(19) United States
(12) Patent Application Publication
(10) Pub. No.: US 2006/0019537 A1
(43) Pub. Date: Jan. 26, 2006

(54) Connector

(75) Inventors: Kazuhisa Ishizaki, Haibara-gun (JP); Eiji Aoki, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/185,672

(22) Filed: Jul. 21, 2005

(30) Foreign Application Priority Data
Jul. 21, 2004 (JP) P2004-212814

(51) Int. Cl. H01R 13/58

(52) U.S. Cl. 439/606

(57) ABSTRACT

An inner housing is molded integrally with terminals such that portions of the inner housing fill respectively in through holes which are formed respectively in the terminals, and extend in a direction perpendicular to a direction of fitting and removing of a connector. The inner housing is disposed in a connector housing.

### BACKGROUND OF THE INVENTION

This invention relates to a connector, and more particularly to a terminal mounting structure of a connector.

Generally, a shielded wire (or cable), having a conductor (also called “core wire”) covered with a shielding wire, is used as a wire such as a signal wire which need to block external noises so as to reduce adverse effects of the external noises to a minimum. In a structure of mounting a connector on such a shielded wire, it is also necessary to shield a connector portion where the shielding wire is peeled and removed from the shielded wire. Therefore, in recent years, there has been used the type of connector in which a connector housing is made of an electrically-conductive material such as aluminum, and the connector portion is shielded by the connector housing. FIG. 6 shows a connector 1 in which a terminal 5 in the form of a male pin terminal is mounted in a female connector housing 3. As shown in FIG. 6, in order to insulate the terminal 5 from the connector housing 3, the terminal 5 is disposed in an inner housing 7 made of an insulative material such as a synthetic resin, and the terminal 5 is disposed in the connector housing 3 through the inner housing 7.

More specifically, the terminal 5 includes a body portion 5b, and an electrical contact portion 5a which extends continuously from the body portion 5b, and is smaller in diameter than the body portion 5b, the electrical contact portion 5a being adapted to be fitted into a mating terminal in the form of a female pin terminal (not shown) . Opposite sides of a portion of the body portion 5b are cut to form flat surface portions 5c. The inner housing 7 is formed into a generally hollow cylindrical shape, and has a stepped through hole 7a for the passage of the terminal 5 therethrough. The terminal 5 is passed through the stepped through hole 7a. A portion of the inner housing 7, corresponding to the flat surface portions 5c, is notched into a generally semi-circular shape to form a retaining groove 7b. Also, a portion of the connector housing 3, facing to the retaining groove 7b, is notched into a generally semi-circular shape to form a semi-circular grove 3a. The terminal 5 is inserted into the stepped through hole 7a in the inner housing 7, and a step portion 5d of the terminal 5, formed at the boundary between the electrical contact portion 5a and the body portion 5b, is brought into abutting engagement with a step portion of the through hole 7a, thereby positioning the terminal 5 relative to the inner housing 7 in an axial direction. Thereafter, the inner housing 7, holding the terminal 5, is inserted into a housing chamber 9 of the connector housing 3. In this condition, the flat surface portions 5c of the terminal 5 is in communication with the exterior of the connector housing 3 via the retaining groove 7b and the semi-circular groove 3a.

Then, a stopper 11, having an engagement portion 11a of a substantially U-shape, is inserted into the inner housing 7 through the semi-circular groove 3a and the retaining groove 7b, and a bifurcated portion of the engagement portion 11a is brought into engagement with the flat surface portions 5c of the terminal 5. As a result, the terminal 5 is mounted in the connector housing 3 in such a manner that this terminal 5 is prevented from withdrawal and rotation.

There is also known a female pin terminal (female terminal) in which a retaining member is inserted into a connector housing from the outside thereof, and is retainingly engaged in a retaining groove formed in an outer peripheral surface of the pin terminal, thereby preventing the withdrawal of the pin terminal (see, for example, Patent Literature 1). Patent Literature 1:JP-A-2003-282175 (Pages 3 to 6, FIG. 1)

The connector of the above construction is formed by combining the separate parts that is, the retaining member, the terminal, the inner housing and the connector housing together, and therefore the number of the component parts is large, so that the time and labor, required for the assembling operation increase. And besides, manufacturing errors of the various parts are accumulated, which leads to a possibility that the terminal deviates from the proper position relative to the housing chamber of the connector housing (particularly in the radial direction), and there is a fear that the operation for fitting the connector to a mating connector is adversely affected. Therefore, it has been necessary to take measures, for example, to enhance the dimensional precisions of the component parts and to increase the inner diameter of the housing chamber so as to absorb the accumulated errors, thereby preventing the undesirable interference of the connector with the mating connector. Furthermore, in order that the stopper or the retaining member can be engaged with the terminal, the flat surface portions or the retaining groove must be formed at the terminal by processing the relevant portion of the terminal. Therefore, there is possibility for improvement from the viewpoint of the cost reduction.

### SUMMARY OF THE INVENTION

This invention has been made in view of the above circumstances, and an object of the invention is to provide a connector in which an assembling error is small, and an assembling operation is easy.

In order to accomplish the above object, a connector of the present invention is characterized by having the following arrangement,

(1) A connector comprising:

a first housing; and

a terminal that comprises:
an electrical contact portion adapted to be connected to a mating terminal; and
a body portion continued from the electrical contact portion and formed with a through hole,

wherein the first housing is integrally molded with the terminal such that a part of the first housing fills the through hole.

(2) A connector according to (1), wherein the through hole extends in a direction perpendicular to a direction in which the terminal is fitted to the mating terminal.

(3) A connector according to (1) further comprising a second housing that is made of conductive material,

wherein the first housing is made of insulative material and is disposed in the second housing.

(4) A method of producing a connector comprising:

providing a terminal that comprises an electrical contact portion adapted to be connected to a mating terminal, and a body portion continued from the electrical contact portion and formed with a through hole; and

integrally molding a first housing with the terminal such that a part of the housing fills the through hole.

(5) A method of producing a connector according to (4) further comprising,

disposing the first housing in a second housing made of conductive material,

wherein the first housing is made of insulative material.

According to the invention, the number of the component parts of the connector is reduced. As a result, accumulated manufacturing errors of the parts are reduced, so that the precision of the connector is enhanced. Therefore, the connector can be positively electrically connected to the mating connector. And besides, the time and labor, required for the assembling operation, can be reduced, so that the production cost can also be reduced. Furthermore, the withdrawal and rotation of the terminal can be positively prevented without the need for forming any retaining portion at the terminal or the need for providing a separate part such as a stopper. Therefore, the reliability of the connector can be enhanced.

According to the invention, the outer housing (the connector housing) shields the connector, thereby reducing adverse affects of external noises. Therefore, a wire, such as a signal wire liable to be adversely affected by external noises, can be positively connected to the connector with the simple mechanism.

### BRIEF DESCRIPTION OF THE DRAWINGS

FIG. 1 is a perspective view of one preferred embodiment of a connector of the invention, showing its overall construction.

FIG. 2 is an exploded, perspective view of the connector of FIG. 1.

FIG. 3 is a vertical cross-sectional view taken along the line III-III of FIG. 1.

FIG. 4 is a vertical cross-sectional view taken along the line IV-IV of FIG. 3.

FIG. 5 is a vertical cross-sectional view of a mating connector for connecting to the connector of the invention.

FIG. 6 is a vertical cross-sectional view of a related connector.

FIG. 7 is a cross-sectional view taken along the line VII-VII of FIG. 6.

### DETAIL DESCRIPTION OF PREFERRED EMBODIMENTS

One preferred embodiment of the present invention will now be described in detail with reference to the drawings.

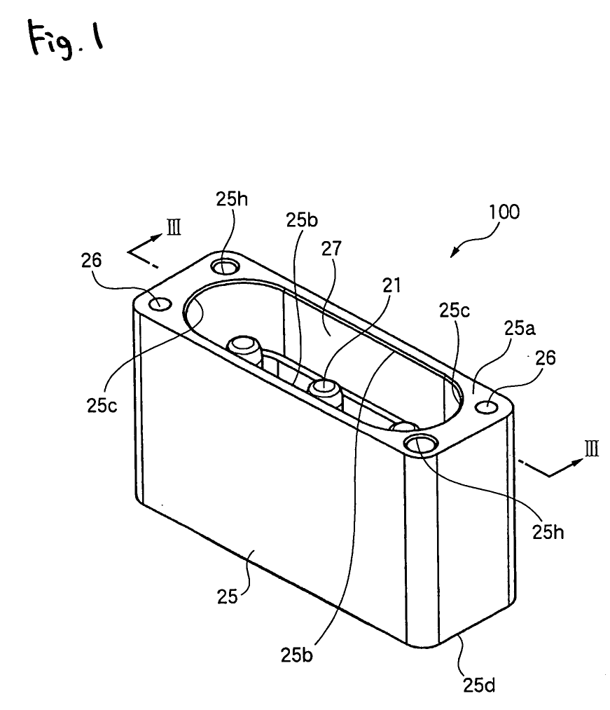

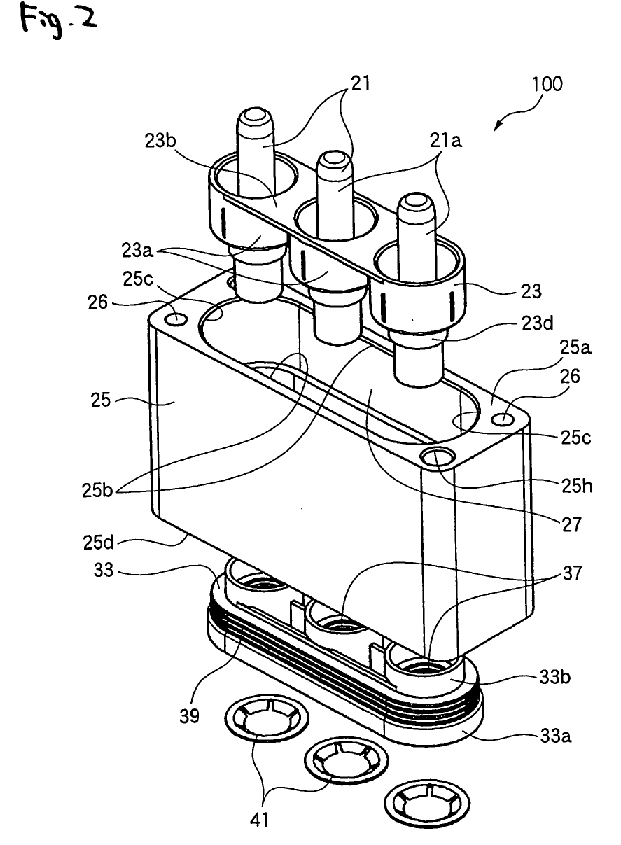

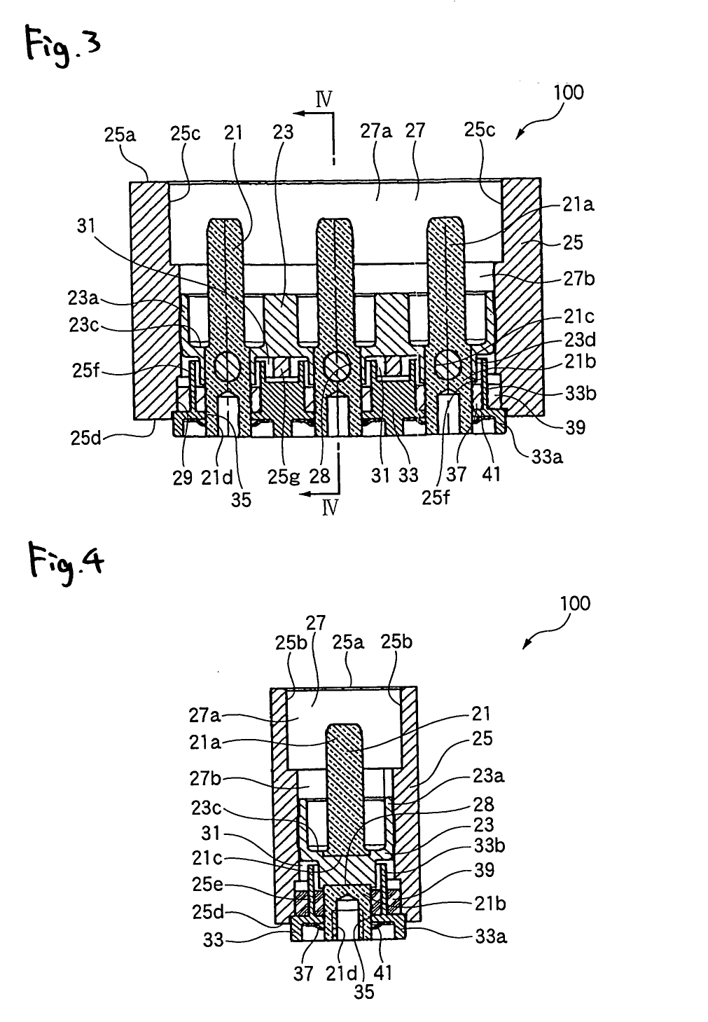

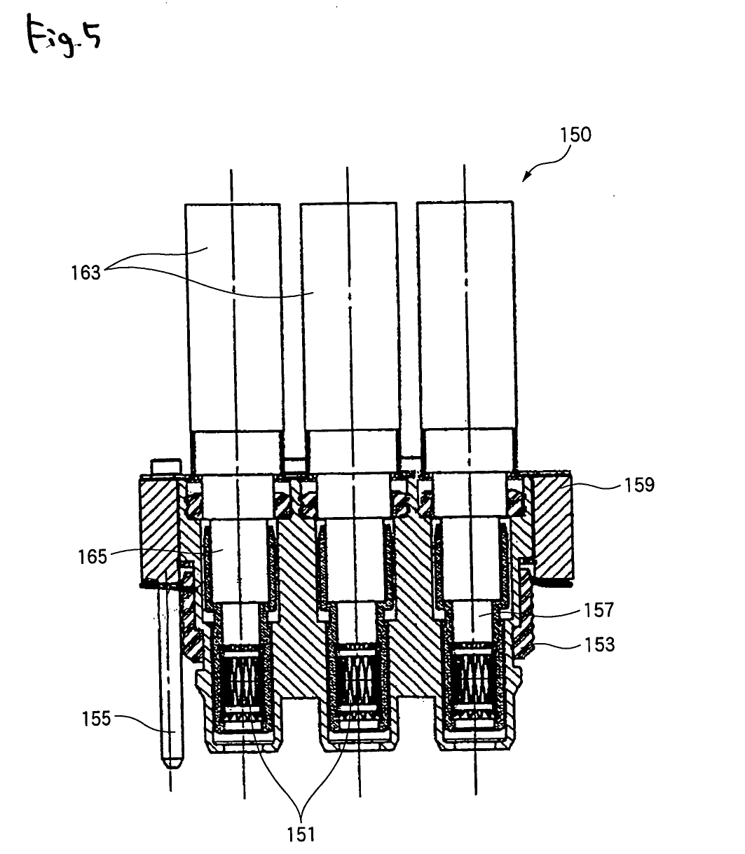

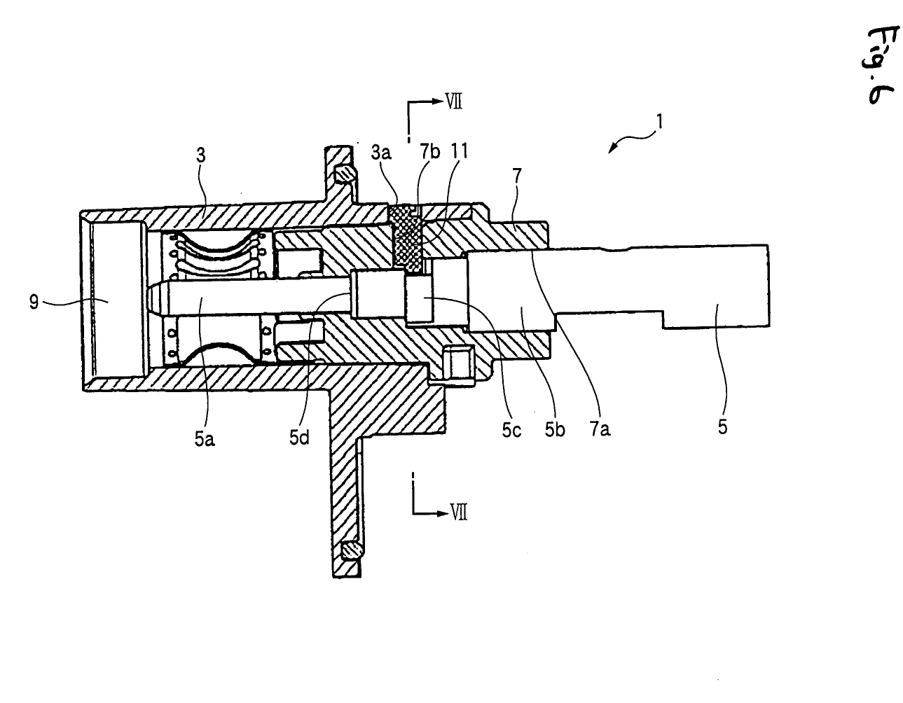

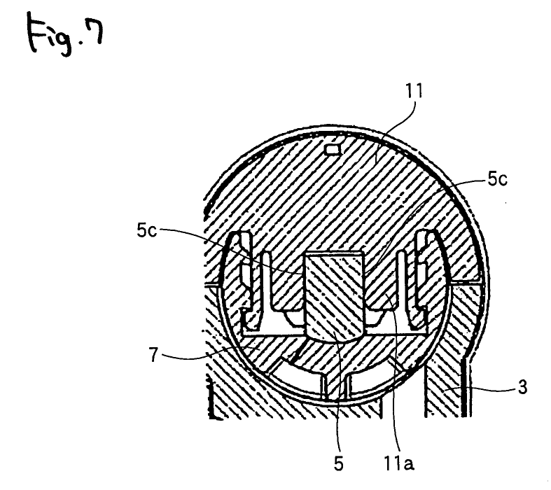

FIG. 1 is a perspective view of one preferred embodiment of a connector of the invention, showing its overall construction, FIG. 2 is an exploded, perspective view of the connector of FIG. 1, FIG. 3 is a vertical cross-sectional view taken along the line III-III of FIG. 1, FIG. 4 is a vertical cross-sectional view taken along the line IV-IV of FIG. 3, and FIG. 5 is a vertical cross-sectional view of a mating connector for connecting to the connector of the invention. Although the invention can be applied to both of male and female connectors, the illustrated embodiment of FIGS. 1 to 4 is directed to the type of connector in which male pin terminals are used as terminals, and these male pin terminals are mounted in a female connector housing.

As shown in FIGS. 1 to 5, the connector 100 of this embodiment comprises the connector housing 25 which can be fitted to and removed from the mating connector 150, and the terminals 21 each including an electrical contact portion 21a for electrical connection to a corresponding terminal 157 of the mating connector 150, and a body portion 21b extending continuously from the electrical contact portion 21a. A through hole 28 is formed through the body portion 21b of each terminal 21, and extends in a direction perpendicular to a direction of fitting and removing of the connector housing 25 relative to the mating connector 150. At least a part of the connector housing 25 is molded integrally with the terminals 21 such that the portions of the connector housing 25 fill respectively the through holes 28 formed respectively through the terminals 21. More specifically, the connector housing 25 includes an outer housing (In FIGS. 1 to 4, reference numeral 25 is used to designate both of the connector housing 25 and the outer housing), and an inner housing 23 which is separate from the outer housing, and can be mounted in the outer housing. The inner housing 23 is molded integrally with the terminals 21 such that portions of the inner housing 23 fill respectively the through holes 28. When the inner housing 23 is mounted in the outer housing, the terminals 21 are mounted in the connector housing 25. The outer housing is made of an electrically-conductive material.

Details of the connector 100 of this construction will be described below.

As shown in FIGS. 1 to 4, the connector 100 of this embodiment comprises the terminals (that is, the male pin terminals) 21, and the connector housing (female connector housing) 25 including the inner housing 23 and the outer housing. In the embodiment shown in FIGS. 1 to 4, the three terminals 21, arranged on a straight line, are disposed in the connector housing 25 through the inner housing 23.

Each terminal (male pin terminal) 21 is made of an electrically-conductive material such for example as nickel-plated copper, and is formed into a cylindrical shape having the electrical contact portion 21a and the body portion 21b which are continuous with each other. The electrical contact portion 21a is smaller in diameter than the body portion 21b so as to be fitted into a resilient contact piece 151 of a substantially hollow cylindrical shape, which is an electrical contact portion of the mating connector 150 (described later) . A distal end of the electrical contact portion 21a is round chamfered so that the electrical contact portion 21a can be easily fitted into the resilient contact piece 151. The through hole 28, defined by a circular inner peripheral surface 21c, is formed in the body portion 21b, and extends through the body portion 21b in a diametrical direction of the body portion 21b. An internally-threaded portion 21d is formed in a proximal end of the body portion 21b, and extend in an axial direction. A bolt (not shown) is passed through a hole in a ring terminal or the like fixedly secured to one end portion of a conductor of a wire (not shown), and is threaded into the internally-threaded portion 21d, thereby fixing the wire to the terminal 21.

The inner housing 23 is made of an insulative synthetic resin such for example as PPS (polyphenylene-sulfide), and this inner housing 23 is molded integrally with the three terminals 21, arranged on a straight line, in such a manner that portions of the inner housing 23 fill respectively in the through holes 28 formed respectively through the terminals 21. The inner housing 23 includes three body portions 23a of a round cup-shape with a closed bottom, and a generally-oval flat plate 23b interconnecting upper ends of the three body portions 23a. A bottom portion 23c of each body portion 23a has a cylindrical portion 23d extending therefrom in a direction away from the open end of the body portion 23a. The cylindrical portion 23d is molded integrally on the body portion 21b of the corresponding terminal 21 so that the through hole 28 can be filled with the molded resin. As a result, part of the synthetic resin, forming each bottom portion 23c and the corresponding cylindrical portion 23d, flows into the through hole 28 in the corresponding terminal 21, so that the terminals 21 are integrally connected to the inner housing 23, and therefore are positively fixed thereto.

That portion of the connector housing 25 except the inner housing 23, that, the outer housing, is made of the electrically-conductive material such for example as aluminum, and has a substantially rectangular box-shape. A fitting hole (space) 27 of a generally oval cross-section is formed in one end surface (upper end surface in FIG. 3) 25a of the connector housing (outer housing) 25, and is defined by straight opposed side surfaces 25b extending respectively along longer sides of the connector housing 25 and generally semi-circular opposite end surfaces 25c extending respectively along shorter sides of the connector housing 25. Similarly, an oval hole (space) 29 of a generally oval cross-section is formed in the other end surface 25d of the connector housing 25, and is defined by straight opposed side surfaces 25e extending respectively along the longer sides of the connector housing 25 and generally semi-circular opposite end surfaces 25f extending respectively along the shorter sides of the connector housing 25. Three through holes 31 of a circular shape are formed through a partition wall 25g forming the boundary between the fitting hole 27 and the oval hole 29, and the fitting hole 27 and the oval hole 29 communicate with each via these through holes 31. The through holes 31 are arranged at a pitch equal to the pitch of the terminals 21.

The fitting hole 27 has two holes 27a and 27b which are similar in shape to each other, and have a substantially oval shape. The first fitting hole 27a of a slightly larger size is disposed close to the one end surface 25, and the second fitting hole 27b is disposed close to the partition wall 25g, and is smaller than the first fitting hole 27a. Thus, the fitting hole 27 is formed as a stepped hole. The first fitting hole 27a is slightly smaller in size than a packing 153 mounted on the mating connector 150 (see FIG. 5). The size of the second fitting hole 27b is equal to an outer size of the inner housing 23, and the inner housing 23 is fitted into the second fitting hole 27b. Internally-threaded portions 25h, corresponding respectively to externally-threaded portions (not shown) formed oh the mating connector housing 150, as well as positioning pin holes 26, corresponding respectively to positioning pins 155 formed on the mating connector 150, are formed in the one end surface 25a of the connector housing 25.

A terminal holder 33 has a substantially oval shape, and is made of a synthetic resin such as PPS. Three circular walls 33b are formed on and extend upwardly from a substantially oval base 33a of the terminal holder 33. A circular hole 35 is formed through a central portion of that portion of the base 33a encircled by each circular wall 33b, the circular hole 35 being slightly larger in diameter than the body portion 21b of the terminal 21. A packing 37 is mounted within each circular wall 33b, and a packing 39 is mounted at an outer peripheral portion of the base 33a, the packings 37 and 39 being made of a rubber material such for example as acrylic rubber.

Next, a procedure of assembling the connector 100 will be described. As shown in FIGS. 3 and 4, the inner housing 23, having the terminals 21 integrally molded therein, is fitted into the second fitting hole 27b of the outer housing of the connector housing 25 while passing the body portions 21b of the terminals 21 respectively through the through holes 31 in the outer housing of the connector housing 25. Then, the packings 33 are inserted respectively into the circular walls 33bof the terminal holder 33, and the packing 39 is mounted on the outer periphery of the terminal holder 33. Thereafter, the terminal holder 33, together with the packing 39, is inserted into the oval hole 29 in the connector housing 25 while passing the body portions 21b of the terminals 21 through the respective packings 37 and also through the respective holes 35 in the terminal holder 33.

As a result, a seal is formed between the body portion 21b of each terminal 21 and the corresponding circular wall 33bof the terminal holder 33, and also a seal is formed between the base 33a of the terminal holder 33 and the oval hole 29 in the connector housing 25. One end portions of the body portions 21b of the terminals 21 project outwardly from the terminal holder 33 through the respective holes 35. Then, the inner housing 23 and the terminal holder 33 are pressed toward each other so as to eliminate a gap therebetween, and push nuts 41 are fitted on the body portions 21b, respectively, and the terminal holder 33 is held by outer peripheral portions of the push nuts 41. Thus, the connector 100 is assembled.

As shown in FIG. 5, the mating connector 150 comprises a male connector housing 159, and the three female pin terminals (terminals) 157 which are mounted in the connector housing 159, and are arranged on a straight line in corresponding relation to the connector 100. The resilient contact piece 151 is provided within one end portion of the terminal 157 of a hollow cylindrical shape made of an electrically-conductive material, and a conductor 165 of a shielded wire 163 is press-fastened to the other end portion of this terminal. The externally-threaded portions (not shown), corresponding respectively to the internally-threaded portions 25h formed in the connector housing 25 of the connector 100, are formed in the male connector housing 159, and the positioning pins 155, corresponding respectively to the positioning pin holes 26 formed in the connector housing 25, are formed on the male connector housing 159.

The electrical contact portions 21a of the terminals 21 are fitted respectively into the resilient contact pieces 151 while inserting the positioning pins 155 respectively into the positioning pin holes 26, and the connector housing 25 is brought into abutting engagement with the male connector housing 159, and the externally-threaded portions (not shown) are threaded respectively into the internally-threaded portions 25h, thereby fastening the two connector housings together. As a result, the terminals 21 are electrically connected respectively to the terminals (female pin terminals) 157.

In the terminal mounting structure of the connector 100 of this embodiment, the inner housing 23, molded integrally with the terminals 21, is disposed in the outer housing of the connector housing 25, and by doing so, the terminals 21 are disposed in the connector housing 25 through the inner housing 23. Therefore, the number of the component parts of the connector 100 is reduced. As a result, accumulated manufacturing errors of the parts are reduced, so that the connector can be positively electrically connected to the mating connector 150. And besides, the time and labor, required for the assembling operation, can be reduced, so that the production cost can also be reduced. Furthermore, the through hole 28 is formed through the body portion 21b of each terminal 21, and extends in the direction perpendicular to the direction of fitting and removing of the connector 100, and the inner housing 23 is molded integrally with the terminals 21 such that portions of the inner housing 23 fill respectively in the through holes 28. Therefore, the withdrawal and rotation of the terminals 21 can be positively prevented without the need for forming any retaining portion at each terminal or the need for providing separate parts such as stoppers. Therefore, the reliability of the connector 100 can be enhanced.

In the terminal mounting structure of the connector 100 of this embodiment, the outer housing of the connector housing 25 is made of the electrically-conductive material. Therefore, the connector housing 25 shields the connector 100, thereby reducing adverse affects of external noises. Therefore, the wires 163, such as signal wires liable to be adversely affected by external noises, can be positively connected to the connector with the simple mechanism.

The present invention is not limited to the above embodiment, and suitable modifications, improvements and so on can be made. The material, shape, dimensions, numerical values, form, number, disposition, etc., of each of the constituent elements of the above embodiment are arbitrary, and are not limited in so far as the invention can be achieved.

For example, in the above embodiment, although the connector housing comprises the outer housing and the inner housing which are separate from each other, there can be used a connector housing having an outer housing and an inner housing which are molded integrally with each other, using a synthetic resin. In this case, also, part of the connector housing (that is, the single connector housing) is molded integrally with the terminals, and this is desirable since the number of the component parts is reduced. With respect to a shielding function of the connector housing of the type in which the outer and inner housings are molded integrally with each other, using the synthetic resin, a suitable shielding member is used for this purpose.

What is claimed is:

1. A connector comprising:
a first housing; and
a terminal that comprises:
an electrical contact portion adapted to be connected to a mating terminal; and
a body portion continued from the electrical contact portion and formed with a through hole,
wherein the first housing is integrally molded with the terminal such that a part of the first housing fills the through hole.

2. A connector according to claim 1, wherein the through hole extends in a direction perpendicular to a direction in which the terminal is fitted to the mating terminal.

3. A connector according to claim 1 further comprising a second housing that is made of conductive material,
wherein the first housing is made of insulative material and is disposed in the second housing.

4. A method of producing a connector comprising:
providing a terminal that comprises an electrical contact portion adapted to be connected to a mating terminal, and a body portion continued from the electrical contact portion and formed with a through hole; and
integrally molding a first housing with the terminal such that a part of the housing fills the through hole.

5. A method of producing a connector according to claim 4 further comprising,
disposing the first housing in a second housing made of conductive material,
wherein the first housing is made of insulative material.
